(19) United States
(12) Patent Application Publication
(10) Pub. No.: US 2025/0373454 A1
(43) Pub. Date: Dec. 4, 2025

(54) APPARATUS FOR PROVIDING A PHYSICAL UNCLONABLE FUNCTION AND MANUFACTURING METHOD

(71) Applicant: FRAUNHOFER-GESELLSCHAFT ZUR FÖRDERUNG DER ANGEWANDTEN FORSCHUNG E.V., München (DE)

(72) Inventors: Dieter Bollmann, München (DE); Alexander Sedlmaier, München (DE)

(21) Appl. No.: 19/226,574

(22) Filed: Jun. 3, 2025

(30) Foreign Application Priority Data
Jun. 4, 2024 (EP) 24401018.7

(51) Int. Cl. H04L 9/32

(52) U.S. Cl. CPC H04L 9/3278

(57) ABSTRACT

Embodiments include a method for manufacturing an apparatus for providing a physical unclonable function based on a characteristic structure. The method comprises: generating the characteristic structure by means of locally demixing (or separating or segregating or decomposing) a precursor to obtain a multitude of domains of a first substance and a multitude of domains of a second substance to obtain a random spatial distribution of the domains of the first and second substances in a measuring region, wherein domains of the first matter and domains of the second matter differ in a physical property so that differences in the physical property at least partially provide the physical unclonable function. Furthermore, embodiments include apparatuses for providing a physical unclonable function.

### CROSS-REFERENCE TO RELATED APPLICATION

This application claims priority from European Patent Application No. EP 24401018.7, which was filed on Jun. 4, 2024, and is incorporated herein in its entirety by reference.

Embodiments include apparatuses for providing a physical unclonable function (PUF) and manufacturing methods for manufacturing such apparatuses. Embodiments include PUF structures by means of spontaneous structure formation, apparatuses with PUF structures by means of spontaneous structure formation, as well as methods for manufacturing such PUF structures and apparatuses.

### BACKGROUND OF THE INVENTION

PUF (or physical unclonable function) structures are used to generate unique non-repeatable keys. The key is used in security-relevant technical systems like a fingerprint to verify the access authorization with respect to stored data.

If the PUF structure has been changed with respect to its properties by means of an attack from the outside, an algorithm detects the difference of the key generated from the currently measured properties and the stored key. This enables the detection of an attack, and a protective measure, such as deletion of the sensitive data, may be employed.

The manufacturing of PUF structures poses a challenge due to contrary goals. On the one hand, the PUF is to be as secure as possible, in particular unclonable, corresponding to as random-based a property of a structure forming the PUF as possible. On the other hand, it is important for the production of such structures that the structures can be easily reproduced, i.e. that they are readily reproducible, that is reproducible in a respective individual random implementation, and, above all, that the structures can be manufactured reliably. Thus, the properties of the apparatuses produced, with the exclusion of the features defining the PUF, should be easy to be predetermined, e.g. with respect to the dimensions of such apparatuses or associated structures.

In light of this, it is the object of the present invention to provide a concept for an apparatus for a physical unclonable function, and an associated manufacturing method enabling an improved tradeoff between the security and the quality of the physical unclonable function, while at the same time achieving robust and reliable manufacturing.

This object is solved by the subject-matters of the independent claims. Inventive further developments are defined in the subclaims.

### SUMMARY

An embodiment may have a method for manufacturing an apparatus for providing a physical unclonable function based on a characteristic structure; the method comprising: generating the characteristic structure by locally demixing a precursor to acquire a multitude of domains of a first substance and a multitude of domains of a second substance to acquire a random spatial distribution of the domains over the first and second substances in a measuring region, wherein domains of the first substance and domains of the second substance differ in a physical property, so that differences in the physical property at least partially provide the physical unclonable function.

Another embodiment may have an apparatus for evaluating a physical unclonable function that can be acquired by the manufacturing method according to the invention.

Another embodiment may have an apparatus for providing a physical unclonable function, comprising: a characteristic structure; wherein the characteristic structure for the physical unclonable function comprises a measuring region with domains of a first substance and domains of a second substance that differs and is separated from the first substance; wherein domains of the first substance and domains of the second substance differ in a physical property.

Embodiments include a method for manufacturing an apparatus for providing a physical unclonable function based on a characteristic structure. The method comprises: generating the characteristic structure by means of locally demixing (or separating or segregating or decomposing) a precursor to obtain a multitude of domains of a first substance and a multitude of domains of a second substance to obtain a random spatial distribution of the domains of the first and second substances in a measuring region, wherein domains of the first matter and domains of the second matter differ in a physical property so that differences in the physical property at least partially provide the physical unclonable function.

The inventors have realized that, based on a demixing (or separation or segregation or decomposition) process, starting from a precursor, domains of at least two different substances may be generated with a random distribution to provide a PUF. To this end, the domains of the first substance and the domains of the second substances can be distinguished on the basis of a physical property, so that, on the basis of the differences, based on the random distribution of the domains, the unclonable function may be at least partially provided.

In this case, partially means that other optional elements or components of the apparatus may have an effect on the unclonable function, i.e. it's definition or verification.

For example, the precursor may be a mixture of at least two substances, or a single substance in which a second substance is dissolved, e.g. by means of a solvent. In this case, a corresponding mixture may be available in homogeneous or inhomogeneous form. In particular, the precursor may also be a mechanical mixture. Prior to the reaction, the precursor may be a coherent substance, which is separated into at least two substances upon change of the ambient conditions (e.g. cooling, heating, pressure change, incidence of light, UV light). “At least two” is used since a corresponding solvent that is removed by pumping may be additionally present. Alternatively or additionally, the precursor may be a composition with two or more homogenously or inhomogeneously mixed components or substances, or include the same, into which, or into at least partial amounts thereof, the precursor may separate. Thus, e.g. a solvent optionally contained in the precursor may dissipate and may be largely or fully non-existent in the separated state.

Thus, the precursor may be a composition from which different domains may be generated by means of demixing. In this case, depending on the implementation of the precursor, demixing may be understood as a multitude of processes leading to the result of different domains.

For example, the precursor may be provided in a first phase, e.g. a liquid phase, e.g. in a homogeneous phase, e.g. or in an essentially homogeneous phase, wherein a phase transition is caused by means of a change of state of a precursor so that the precursor is decomposed at least partially, i.e. at least locally, into the individual domains. In general, at least two different types of domains or phases may be generated. Embodiments may also comprise more than several different domains or phases, e.g. in a characteristic structure with three phases.

For example, such demixing may also include the evaporation of an optional solvent so that, on the basis of the precursor, domains of one or several solved components are formed.

The demixing-based generation of the domains enables simple and above all reliable manufacturing of apparatuses for providing a physical unclonable function. For example, demixing processes may be controlled reliably via cooling curves or pressure changes to ensure a well-reproducible manufacturing process, wherein the demixing leads to an inherently random-based domain distribution and therefore high security of associated PUFs.

Thus, it is a central idea to select a demixing process that may be reliably and controllably caused and may optionally also be stopped (e.g. if a desired domain property, such as a domain size, is achieved) but that leads to a random domain distribution in the characteristic structure.

In other words, embodiments include PUF structures with a non-repeatable domain distribution in the characteristic structure, with which a key that enables the detection of whether this structure has been changed may be generated.

According to embodiments, the method further includes arranging a measuring structure, for measuring the physical property, at a multitude of sub-regions in the measuring region to evaluate the physical unclonable function.

An arrangement of the measuring in selected sub-regions enables the evaluation of the random distribution of the domains on the basis of the physical property. In particular, measuring strips, measuring grids or mesh structures may be used for measurement to ensure high flexibility of the apparatus, e.g. as a film, for example. The distance of measuring points with respect to each other may be below 100 μm, for example, to ensure close monitoring.

According to embodiments, locally demixing the precursor is carried out by means of a self-organization and/or a spontaneous structure formation of the first and second substances. The inventors have realized that demixing processes leading to a self-organization or spontaneous structure formation enable a random-based distribution of the domain, while being easily realized with respect to manufacturing. In particular, self-organization or spontaneous structure formation may be carried out in a controlled way by means of process parameters to set a random distribution of the domains on the one hand, but favorable domain properties, such as volumes of the individual domains, on the other hand.

According to embodiments, the precursor is provided in a first phase and locally demixing the precursor comprises a change of a state of the precursor to cause a phase transition to obtain the multitude of domains of the first and second substances.

For example, the phase transition may be from a liquid phase to a solid phase, but may also be from a homogeneous phase to a heterogonous phase. For example, a solid substance precursor may have a homogeneous distribution of two substances that arrange themselves in order and form individual domains that are also solid. A homogeneous mixture may be separated into individual domains, e.g. in the form of a liquid heterogeneous mixture, with individual liquid or highly viscose (e.g. gelatinous) domains, or a liquid mixture or mechanical mixture may be solidified into individual solid domains.

According to embodiments, locally demixing the precursor is caused on the basis of a change of a temperature of the precursor (e.g. cooling, heating), and/or on the basis of a change of the ambient pressure of the precursor (e.g. pressure change of the precursor), and/or based on a radiation of the precursor (e.g. incidence of light, e.g. with UV light), and/or based on a polymerization of the precursor. Alternatively or additionally, the precursor may further include a solvent, and locally demixing the precursor may be caused on the basis of evaporation of the solvent. In particular, ambient conditions of the precursor may be changed to form the domains. Alternatively or additionally, the demixing (e.g. local demixing) or polymerization may be triggered by addition of a further substance, such as a catalyst.

Readily controllable manufacturing of inventive apparatuses may be provided by means of the above process steps, i.e. e.g. changes of states.

According to embodiments, locally demixing the precursor is caused on the basis of an aggregation of the first substance to first aggregation cores and/or an aggregation of the second substance to second aggregation cores, and the method further comprises adding particles to the precursor, wherein the particles are configured to form aggregation cores for the multitude of domains of the first and/or second substance when locally demixing the precursor.

The manufacturing process may be accelerated by means of aggregation cores, i.e. e.g. particles, which may form nucleation sites for the growth of domains. Demixing inhibitors, such as the boiling delay of an overheated liquid, can thus be avoided.

Here, it is to be noted that embodiments may generally comprise demixing processes including domain growth. That is, the domains may increase and grow on the basis of nucleation sites. This enables selectively stopping the process, e.g. if the domains have reached desired properties, such as a certain size.

According to embodiments, in the local demixing by means of a change of the ambient conditions, the precursor is decomposed in at least three substances, wherein the multitude of domains is formed by at least two of the three substances. For example, the precursor may include a solvent that volatilizes or is pumped off during demixing, so that only the substances of the domains remain in the apparatus in the form of the domains.

Embodiments include an apparatus for providing a physical unclonable function with a characteristic structure, wherein the characteristic structure for the physical unclonable function comprises a measuring region with domains of a first substance and domains of a second substance that differs and is separated from the first domain, and wherein domains of the first substance and domains of the second substance differ in a physical property.

According to embodiments, the apparatus further includes a measuring structure configured to measure the physical property at a multitude of sub-regions in the measuring region to evaluate the physical unclonable function.

Embodiments include an apparatus for evaluating a physical unclonable function, which is created by a manufacturing method disclosed herein and in particular above.

Apparatuses according to embodiments are based on the same, or similar, findings and therefore include the same or corresponding advantages as the above-described methods. In particular, apparatuses according to embodiments may include features, details and functionalities disclosed in the context of inventive methods. The same applies for apparatus features that are to be understood at the same time as corresponding method steps.

Thus, the above apparatuses enable simple and reliable manufacturing and in particular an implementation with precisely adjustable properties of the apparatus, such as layer thicknesses, since the stochastic property for the PUF is addressed in the domain distribution and not in the dimensioning of the apparatus.

According to embodiments, the apparatus is a flat bendable film or a coating. Thus, an object to be protected may be simply and securely enclosed and therefore protected.

According to embodiments, a thickness of the characteristic structure of the film or a thickness of the characteristic structure of the coating is essentially constant. For example, a thickness of the characteristic structure may fluctuate by at most +/−2.5% or at most +/−5% or at most +/−10% or at most +/−20% in the measuring region. This enables manufacturing by means of reliably reproducible manufacturing processes, since providing the PUF due to thickness variations is not required, e.g. which is realized in manufacturing processes operated in the limit range.

Furthermore, an essentially constant, i.e. e.g. approximately constant, thickness has the advantage that the film is also well suited for objects that require a surface that is as flat as possible and, in particular, as an intermediate layer for other layers that require a surface that is as flat, i.e. smooth, as possible.

According to embodiments, domain boundaries between the first substance and the second substance extend to a predominant part, e.g. at least 50% or at least 75% or at least 90%, across an entire thickness of the characteristic structure. This makes it possible to design measuring points or measuring locations for the PUF in the form of measuring values of the physical property that are essentially determined by a domain type. This means that more extreme values of the physical property are measured at the respective measuring points and not average values of different domains, which improves the quality of the PUF.

According to embodiments, the domains of the first and second substances are configured to not change or only slightly change their relative arrangement with respect to each other and the physical property for at least one year or for at least five years or for at least 10 years without external influence so that the key due to the physical unclonable function remains unchanged. Thus, the PUF may be evaluated with great robustness and reliability.

According to embodiments, the apparatus comprises a measuring structure configured to measure the physical property at a multitude of sub-regions in the measuring region to evaluate the physical unclonable function. In this case, the measuring structure comprises conducting tracks in two conducting track planes that cross each other and are configured to form the physical unclonable function by a measurement of capacitance values of the characteristic structure at sub-regions at which the conducting tracks of the two conducting track planes cross.

The inventors have realized that an evaluation of the capacitance values at the different domains enables a particularly robust and reliable definition of a PUF.

According to embodiments, the characteristic structure is at least partially, or optionally even fully, arranged between the two conducting track planes. This enables readability of the PUF with low complexity.

According to embodiments, the characteristic structure is arranged at least partially between one of the conducting track planes and a shield structure. Alternatively or additionally, the characteristic structure may be arranged at least partially between a first conducting track plane of the two conducting track planes and a first shield structure and between a second conducting track plane of the two conducting track planes and a second shield structure. The inventors have realized that the PUF may be improved by means of an influence of scattering capacitances by means of the capacitive influence of domains between conducting track planes and a shield structure. To this end, the characteristic structure may be located only on one sheet between the conducting track structure and the conductive shield, so to speak, however, it may also be located on two, i.e. e.g. both, sides between the conducting track plane and the conductive shield.

According to embodiments, a volume of the characteristic structure in sub-regions at which the conducting tracks of the two conducting track planes cross is formed at least to 75% or at least to 80% or at least to 90% or at least to 95% by a single domain of the first or by a single domain of the second substance.

Thus, extreme values of the physical property are essentially measured at the respective measuring points, and average values of different domains are not measured, improving the quality of the PUF.

According to embodiments, a ratio of an overall volume of domains of the first substance and of domains of the second substance of the characteristic structure is between 30:70 and 70:30, or between 40:60 and 60:40, or between 45:55 and 55:45.

This enables a provision of particularly meaningful and therefore secure PUFs.

### BRIEF DESCRIPTION OF THE DRAWINGS

Embodiments of the present invention will be detailed subsequently referring to the appended drawings, in which:

FIG. 1 shows a schematic view of a preprocessor and an apparatus for providing a physical unclonable function according to embodiments;

FIG. 2 shows a symmetrical Gaussian distribution;

FIG. 3 shows a Poisson distribution;

FIG. 4 shows a schematic view of an apparatus according to embodiments with optional conducting tracks;

FIG. 5 shows a schematic view of an apparatus according to embodiments with optional shields;

FIG. 6 shows a top hat distribution;

FIG. 7 shows a distribution with two maximums; and

FIG. 8 shows a schematic view of a characteristic structure on the basis of a structure formation with a mix of PS and PVME.

### DETAILED DESCRIPTION OF THE INVENTION

Before subsequently describing embodiments of the present invention in detail on the basis of the drawings, it is to be noted that identical and functionally identical elements, objects and/or structures and elements, objects, and/or structures having the same effect are provided with the same or similar reference numerals in the different drawings so that the description of these elements illustrated in different embodiments is interchangeable or may be applied to each other.

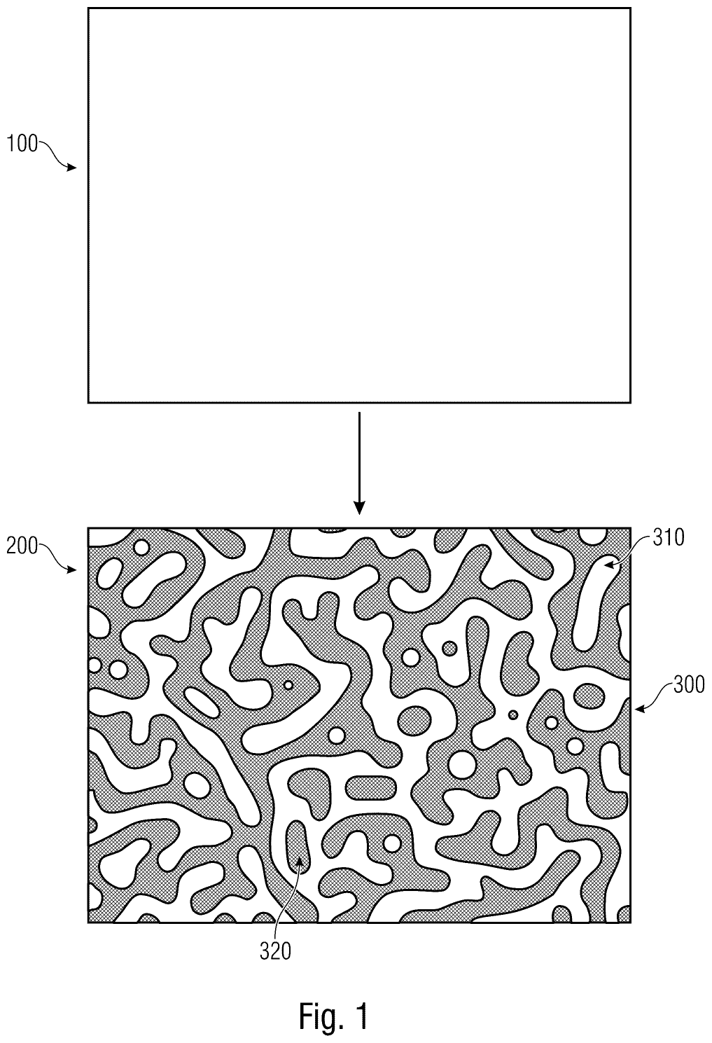

FIG. 1 shows a schematic view of a precursor and an apparatus for providing a physical unclonable function according to embodiments. FIG. 1 shows a precursor 100 and an apparatus for providing a physical unclonable function 200 with a characteristic structure 300.

The characteristic structure 300 comprises, for the physical unclonable function, a measuring region with domains 310 of a first substance and domains 320 of a second substance that differs and is separated from the first substance. The domains 310 of the first substance and the domains 320 of the second substance differ in a physical property.

According to embodiments, a method for manufacturing an apparatus for providing a physical unclonable function includes generating the characteristic structure 300 by locally demixing the precursor 100, or by locally demixing substances of the precursor, to obtain a multitude of domains 310 of the first substance and a multitude of domains 320 of a second substance to obtain a random spatial distribution of the domains of the first and second substances in a measuring region. As explained above, domains 310 of the first substance and domains 320 of the second substance differ in their physical properties so that differences in their physical property at least partially provide the physical unclonable function.

In this case, generating the domains may be based on a self-organization and/or a spontaneous structure formation of the first and second substances, for example. In particular, a phase transition of the precursor 100 may be caused, e.g., by means of a change of temperature, the pressure, and by means of radiation, to form the domains 310, 320.

Forming the domains 310, 320 may further be caused by polymerization or by evaporation of a solvent. Furthermore, particles (e.g. contaminations) may be selectively introduced into the precursor, which may serve as nucleation sites for domain growth.

In the following, a multitude of optional features of embodiments is explained. It is to be noted that the following features, details and functionalities may be integrated individually or also in combination into an apparatus according to FIG. 1 or a corresponding method according to FIG. 1. In particular, embodiments based on the measurement of capacitances (in particular their dielectrics or stray fields) formed by portions of the characteristic layer are disclosed. It is to be noted that the functionalities disclosed in the context of such embodiments are not limited to measurements of electrical capacitance. Domains of different dielectric constants may be replaced by means of domains of different hardness or colors or any other measurable property, according to embodiments, wherein corresponding measuring structures then do not carry out electrical measurements, for example, but are formed in the form of optical sensors (e.g. for color), for example.

In the following, PUF structures (e.g. 300) according to embodiments as well as such apparatuses (e.g. 200) including such characteristic structures and corresponding manufacturing methods are disclosed, wherein the PUF structure may be generated by spontaneous structure formation, as an example of a demixing process, for example.

Apparatuses according to embodiments and in particular associated characteristic structures (e.g. 300), i.e. e.g. PUF structures, may optionally be configured to include an item to be protected. To this end, an implementation as a coating is also possible. By means of a non-repeatable fingerprint in the structure, i.e. e.g. the distribution of the domains (e.g. 310, 320), a key may be generated (e.g. by means of an evaluation of the physical property), which may be used to detect whether the structure (e.g. 300) has been changed. Among other things, embodiments describe a layer (e.g. 300) generated by spontaneous structure formation and generating this key.

Among other things, embodiments therefore address problems in which PUF structures (physical unclonable functions) may be used to generate unique non-repeatable keys. For example, the key may be used like a fingerprint in security-relevant technical systems to check an access authorization with respect to stored data.

If the PUF structure (e.g. 300) has been changed in its properties by an attack from the outside, embodiments enable, e.g. by means of an algorithm, detecting the difference of the key generated from the currently measured properties and the stored key. This may help to detect an attack, and a protective measure, such as deletion of the sensitive data, may be employed.

To this end, apparatuses according to embodiments may be provided in the form of flat bendable films, for example, so that associated PUF structures may be used to protect an item against attacks. To this end, they may be wound around the item until they enclose the same, e.g. fully. The item to be protected (i.e. e.g. an object to be protected) may be a data storage, an electronic circuit, an identification for preventing product piracy or an apparatus for the authentication of rights in the communication of computers, banks or government agencies.

Apparatuses according to embodiments enable efficient manufacturing and high reliability of the characteristic structure. Such efficiently manufacturable and reliably applicable PUF structures may comprise the following properties, individual or in combination:
Apparatuses according to embodiments may be provided in the form of flat bendable films that may be wrapped around the item to be protected.
Apparatuses according to embodiments may be configured such that they are not damaged and/or essentially do not have their properties changed during wrapping and folding. The key-generating properties may remain unchanged for a long time (e.g. more than 10 years, e.g. after corresponding wrapping and folding). For example, in folding and wrapping the film around the object to be protected, the capacitances may change in a measurable way (albeit only slightly, for example). Thus, for example, an “initialization measurement” may be performed only after the folding or wrapping process. In this case, the initialization measurement may include an evaluation of the physical unclonable function, i.e. e.g. a determination of a function in the folded or wrapped state of the film, with respect to which a comparison is made during subsequent monitoring of the object. Furthermore, embodiments make it possible that a corresponding change (e.g. after wrapping or folding, e.g. after the initialization measurement) is smaller than the threshold value defined for detecting a change. The physical properties the key is based upon may be or have to be stable in the long term so that an unambiguous differentiation may be made as to whether the key remains credibly unchanged or has been changed on purpose.
According to embodiments, the long term stability may be fulfilled for ambient conditions as required in vehicle manufacturing.
Embodiments enable keeping the properties regardless of a power supply.
According to embodiments, the structural size may be in the range of approximately 100 μm (e.g. with domain sizes between 50 μm and 150 μm) to be able to detect attacks according to the conventional technology.

Optionally, the PUF structure according to embodiments may also be manufactured in the form of a coating by directly coating the item, instead of a film wrapped around the item.

According to embodiments in which the PUF structure is realized by a film (or in which the apparatus is a film, for example), the apparatus may comprise a structure of conducting tracks on both sides of the PUF structure. The substrate, i.e. the characteristic structure, in between acts as a dielectric with the property thickness and permittivity. These determine the local value of the capacitance between the conducting tracks.

The multitude of electrical conducting tracks cross each other in uniform structures, for example. At the crossing points of the grid, there are many small capacitances that are summed up to a pattern of combined capacitances via the network. If the thickness or the permittivity fluctuates locally stochastically and is different at the different crossing points, the individual capacitances also have different values. The PUF key may be generated by evaluating the pattern of the different capacitances.

Once an attacker tries to penetrate the PUF foil by mechanical force (e.g. cutting, drilling, slitting) to get access to the protected content, the geometrical and electrical conditions of the conducting tracks change, and therefore, the PUF key changes. During activation, if currently read PUF keys differ from originally stored keys, an attack is detected, and access is denied, e.g. by deleting all data.

In this case, embodiments enable a random pattern of permittivity due to the random pattern of domains of the first and second substances, leading to different capacitances and therefore to a stochastic capacitance pattern due to their deviating properties at the measuring points.

In this case, by using the demixing of the precursor, embodiments enable generating such a pattern of capacitance deviations for the PUF, without relying on a variation of the thickness of the characteristic structure or mixing a foreign substance into the layer, such as a granulate into the dielectric. In this case, such a granulate may have a permittivity that differs from the matrix, and may thus cause the variation. However, since the granulate replaces only part of the thickness of the layer, the resulting dielectric effect with respect to the capacitance only changes in part. In contrast, the demixing-based domain formation enables formation of significantly varying physical properties and therefore a particularly meaningful PUF. However, embodiments may additionally include such granulates. For example, they may be used as nucleation sites for domain formation.

In the following, advantages of embodiments are explained further.

Conventional approaches hope that a variation of the capacitances takes place by a statistical variation in the parameters during manufacturing of the structures. In particular, the thickness of the dielectric layer essentially determines the capacitance. To be obtain differences in the capacitances that may be evaluated by measurement, according to conventional approaches, at least one parameter of the manufacturing may significantly and uncontrollably vary. However, this is in contrast to expert processes and the philosophy that dominates in each functioning manufacturing line, i.e. the maximum possible homogeneity and minimum variation of all parameters. Existing production machines in the semiconductor industry would have to be operated in a deliberately unclean or borderline manner so that the layer produced shows the desired variations.

A distribution of a parameter resulting from the variation in manufacturing may be represented as a distribution function. It has an average value that occurs most frequently, and above and below are the deviations from the average value desired for the PUF structure, which are used for key generation.

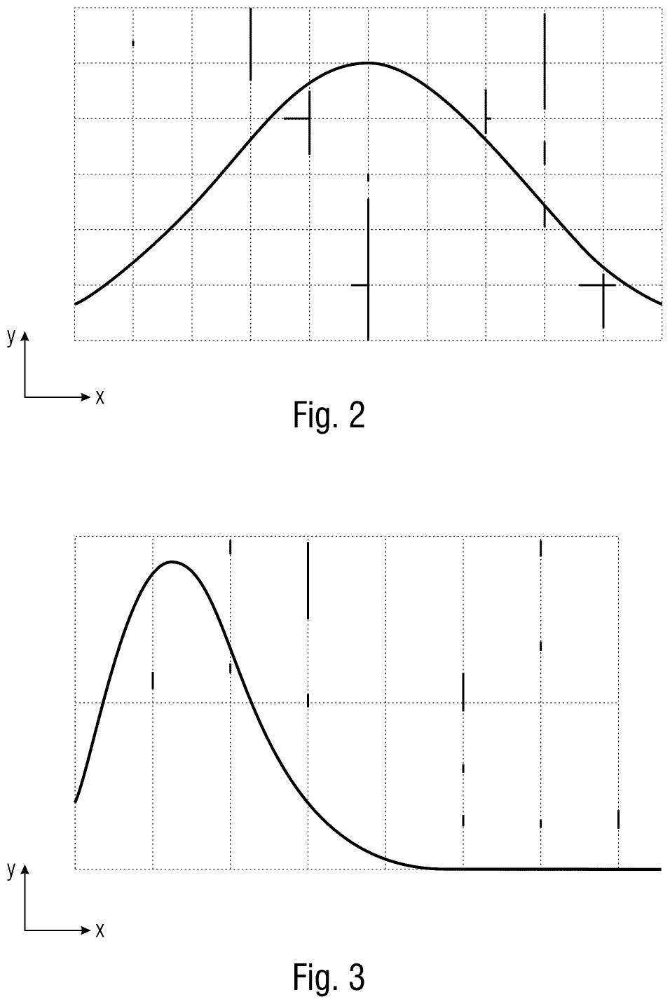

For small deviations from the desired average value, the distribution is symmetrical around the average value and may be approximated by a Gaussian distribution (cf. FIG. 2 which shows a symmetrical Gaussian distribution: y axis: frequency of thickness values, x axis: thickness values). This is appropriate for modern, stabile deposition processes if the values only vary by a few per mille.

To have a measurable effect on the capacitance, the variation in layer thickness should or has to be in the order of magnitude of the layer according to conventional approaches. Such a large variation and layer thickness is better described by the Poisson distribution (cf. FIG. 3, which shows a Poisson distribution: y axis: frequency of thickness values, x axis; thickness values. The Poisson distribution starts at a thickness value of 0). It shows very clearly that values of zero can also occur frequently. The changes of thickness of an insulating layer can therefore become so large that the thickness becomes zero and short circuit occurs. This would render the structure unusable and the structure would therefore be rejected.

This shows that the random layer thickness distribution cause by a poorly controlled process inevitably leads to high scrap rates in production.

Similar to the layer thickness, the same applies to any other homogenous physical parameter that is to be used to generate PUF structures.

By employing the variation and the distribution of the domains by means of demixing, since embodiments do not rely on a variation of the thickness of the characteristic structure, embodiments therefore enable homogenous production processes without borderline operation of the machines. For further explanation, inventive solutions are described in more detail in the following.

Instead of provoking random deviations of the key-generating parameters by “bad” manufacturing process—i.e. with intentionally large variation—embodiments enable the use of a stable process with two alternating states of the parameters used for key generation. Thus, it is possible to manage significantly different capacitances on the small capacitors without the risk (or with very little risk) of failure of the entire structure.

For example, the PUF structure may be generated by demixing or self-organization or spontaneous structure formation during the layer generation. In this case, the dielectric layer may be deposited by at least two components that cannot be mixed in the solid state. An initially homogenous liquid phase can be deposited using the usual processes of the semiconductor industry (e.g. screen printing, squeegee, spraying, spin coating). The thickness may be essentially homogenous, e.g. essentially constant, during the position and also after curing.

For example, during curing which may occur by cooling, evaporation of the solvent, polarization, or condensation, the energetically-favorable state can shift away from the (e.g. homogenous) mixture towards demixing. A mixture gap may therefore occur. Here, the two components separate spatially into small domains. Demixing may occur spontaneously, starting with infinitesimal variations, without any predictable order. The spatial distribution of the parameters is therefore purely random and non-repeatable.

According to the invention, the varying parameter used to generate the PUF key is preferably the dielectric constant (or permittivity). The pair of demixing components may be selected so that this parameter differs significantly, but the other properties relevant to the demixing process are as similar as possible.

Other physical quantities may also be evaluated to generate a PUF key. Thus, according to embodiments, e.g. the local variation and magnetic permeability, electrical conductivity, optical absorption, optical scattering, color, refractive index, or hardness may be used to generate a key.

This temporal development of the phase separation may be described mathematically, for example, by the Cahn-Hilliard equation. The behavior during phase separation is determined by the diffusion constant, the relative concentration of the two components, and the transition zone between the phases. Reference is made to wikipedia.org/wiki/Phase_separation and wikipedia.org/wiki/Cahn % E2%80%93Hilliard_equation.

At this point, reference is again made to FIG. 1. The characteristic structure 300 shows a simulated distribution of the domains 310, 320, e.g. in phase separation. The distribution of the domain in phase separation is represented by the different domain regions 310, 320 (white/black).

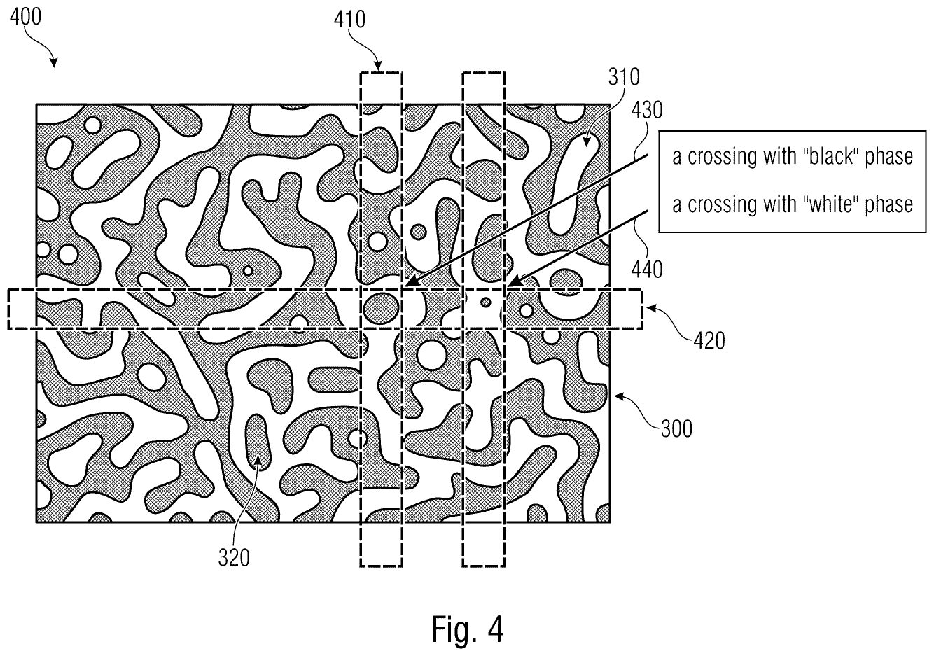

FIG. 4 shows a schematic view of an apparatus according to embodiments with optional conductive tracks. FIG. 4 shows the apparatus 400 which, in addition to the characteristic layer 300 with the domains 310 and 320 of the first and second substances, comprises conductive tracks 410 and 420. As shown in FIG. 4, e.g., crossing points or crossing sites 430, 440 (also referred to as crossings) of the conductive tracks may be located either above one phase or above the other phase or above a mixture.

For example, the region of the apparatus in which conductive tracks 410, 420 are arranged may form the measuring structure or at least part of the measuring structure. The sub-regions in which the physical unclonable function is evaluated may then correspond to the overlapping regions 430, 440 of the conductive tracks which form the capacitances.

At this point, it should be noted that demixing processes according to the invention make it possible to “freeze” a state shown in FIG. 4, i.e. the domain distribution, in such a way that the relative arrangement of the domains 430, 440 with respect to each other and the physical property do not change, or change only to such a minor extent, for at least one year or for at least five years or for at least ten years, without external influence, that the key remains unchanged due to the physical unclonable function.

For the use as a film for PUF keys, a two-dimensional solution of the equation is preferred. That is, according to embodiments, the domains may be larger than the layer thickness, so that the phase boundaries may extend perpendicularly through the layer. The relative concentration of the components may also preferably be approximately 50% to 50% so that the two phases occur equally frequently in the final layer. However, other ratios that still allow a meaningful evaluation are possible, e.g. a ratio of the total volume of domains of the first substance and domains of the second substance of the characteristic structure of between 30:70 and 70:30 or between 40:60 or between 45:55 and 55:45. For example, the cooling curve and/or other parameters may be used to control a manufacturing process according to the invention in such a way that the growth of the domains or phases is frozen when the size of the domains or phases roughly corresponds to the size of the individual measuring sub-regions, e.g. overlapping regions of the conductive tracks, e.g. capacitances, or is up to approximately twice as large.

Since, according to the invention, the domains may extend through the entire layer thickness, this is a significant improvement over conventional approaches having a granulate mixed in. The variation in dielectric properties may be achieved to a much greater extent according to embodiments.

Not only the dielectric layer between the conductive tracks contributes to the measured capacitance, but also the layer between the shield and the conductive tracks. A shield, e.g. made of metallic foil, may be provided or may even be necessary to shield against external fields. The layer structures in domains may therefore be located between the conductive tracks and/or above and/or below them.

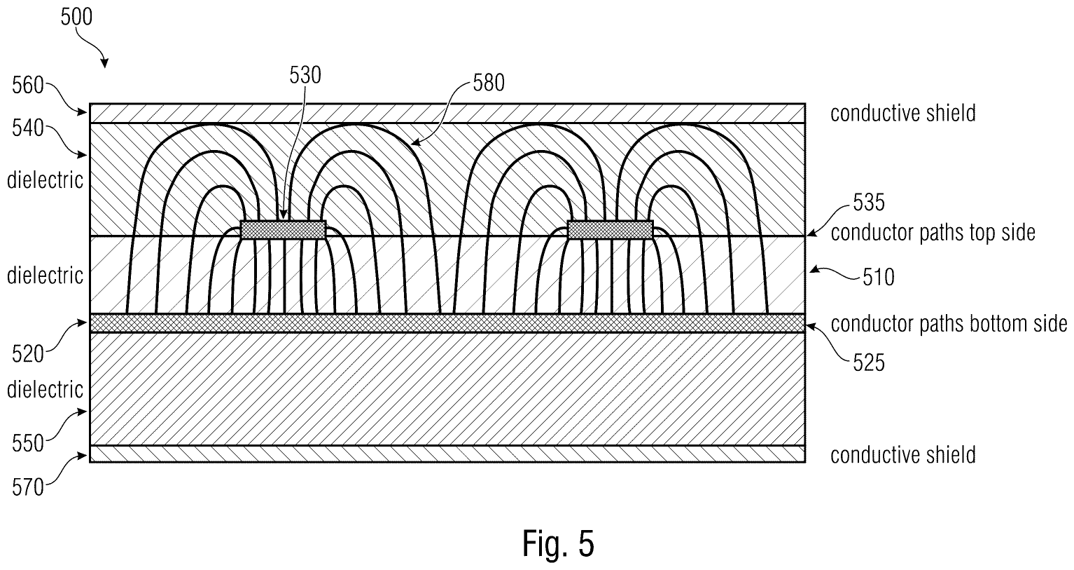

In this regard, reference is made to FIG. 5. FIG. 5 shows a schematic view of an apparatus according to embodiments with an optional shield. In other words, FIG. 5 shows a sketch of the layer structure and the field line progression including stray fields (here without sketching different domains by phases separation).

The apparatus 500 includes an inner layer 510 in the form of a characteristic structure, formed as a dielectric. For example, the layer 510 may correspond to the layer 300 (or part thereof) of FIG. 1. Furthermore, the apparatus 500 comprises conductive tracks, arranged so as to overlap, in separate conductive track planes, i.e., conductive tracks 520 in a lower plane 525 and conductive tracks 530 in an upper plane 535.

As further optional features, the apparatus has further regions 540, 550 of the characteristic structure between the conductor track planes 525 and 535 and outer shields 560, 570. The regions 540 and 550 are configured as dielectrics. Examples of field line progressions are shown with lines 580.

With reference to FIG. 5, the measuring structure may therefore comprise conductive tracks 410, 420 in different (e.g. adjacent) conductive track planes. The conductive tracks 410, 420 may be used to measure a capacitance value influenced by the characteristic structure (e.g. 510 or also 510+540+550) between the conductive track planes, e.g. at intersections (or crossings) of the paths.

The overlapping or crossing of conductive tracks is clearly visible when looking at FIGS. 4 and 5 together. The conductive tracks may be arranged in different, e.g. parallel, planes and intersect in a projection, essentially perpendicular to a plane of the characteristic layer, so that the conductive tracks form capacitors at the overlapping regions 430, 440.

In more general terms, the measuring structure may therefore have sub-regions (e.g. if the regions around which the conductive tracks overlap, e.g. regions of the characteristic structure 430, 440) where the physical property is measured, or a variable on which the physical variable has an influence (e.g. property: permittivity—measurement: voltage), to provide the PUF based an evaluation of a large number of such sub-regions.

As shown in FIG. 5, the characteristic layer may extend between the conductive track planes or even beyond, e.g. if the presence of the characteristic layer has an influence on the measuring region, as in the case shown due to stray fields. Here, any combinations are possible, i.e. a design with only layer part 510, or 510+540, or 510+550, or 510+540+550 (optionally with associated shields in each case).

In general, embodiments may have a shield layer that reduces an environmental influence on the property to be measured or shields against the same. The shields 560, 570 are conductive in this example to prevent the environment from influencing the electrical measurement. For example, in the case of optical evaluation of the characteristic layer, a coating could also be used as a shield. In other words, the shield can be tailored to the specific statistically distributed property of the characteristic layer.

The domain boundaries shown in FIG. 4 may extend in the thickness direction of the characteristic structure, e.g. in FIG. 5 between the two conductive track planes 525, 535, over a predominant portion, e.g. at least 50% with respect to the number of domain boundaries, over an entire thickness of the characteristic structure (510, 540, 550).

In particular, as shown in regions 430 and 440, this may enable a volume of the characteristic structure 300 is formed, in sub-regions where the conductive tracks 410, 420 of the two conductive track planes 525, 535 cross each other, by at least 75% or at least 80%, or at least 90%, or at least 95% either by a single domain of the first substance or by a single domain of the second substance. This enables measurement of physical property values that differ as greatly as possible from one another, and thus a meaningful PUF.

At this point, the advantage of apparatuses according to embodiments is pointed out again, namely that the characteristic structure 510 (or also 540 and 550) may be formed with a constant thickness, e.g. between the planes 525 and 535, since the stochastic property is based on its composition and not on its geometry.

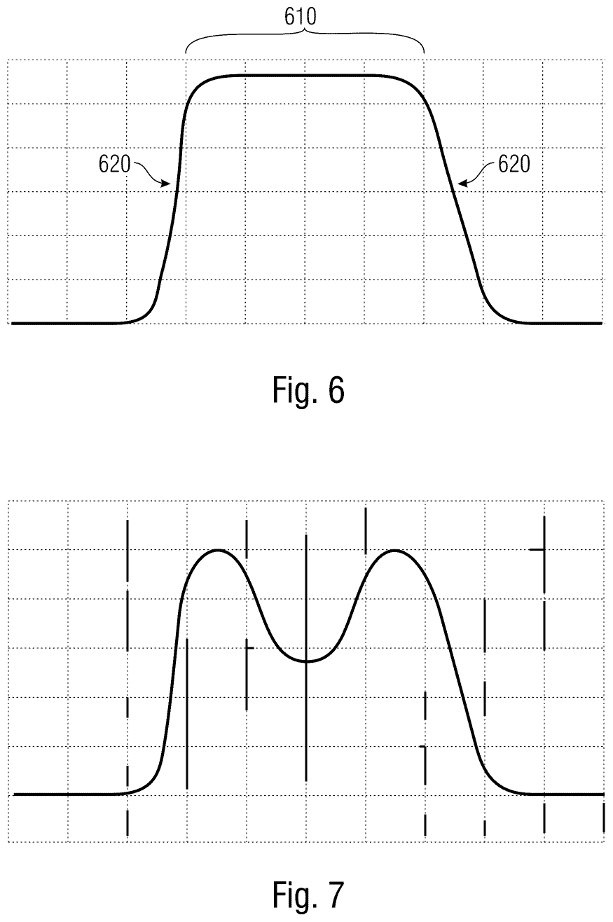

For the generation of a PUF key, a top hat distribution would be preferable to a Gaussian distribution, cf. e.g., FIG. 6. The same has an almost uniform distribution in the value range 610, which can be used for key generation. At the edge 620 of the value range, the frequency drops steeply to quickly approach zero for values that deviate significantly. Values that deviate significantly are therefore very rare. This eliminates the risk of product failure and ensures that the overall process is stable and reliable. However, the idealized uniform distribution in the middle range is not technically realistic.

A layer consisting of two phases with different parameters would typically generate a distribution with two maximums, cf. FIG. 7, for example. This is ideal for the use as a PUF key. One or the other maximum value of the physical property, e.g. in the form of the permittivity, is measured once one or the other component is preferentially located within the respective measuring sub-region, e.g. a capacitor. If the phase boundaries lie within the measuring sub-regions (e.g. capacitors), intermediate values may also be measured. Very high or very low values practically never occur. This makes it a reliable process with little or no risk of failure. For the calculation of a PUF key, it is advantageous if one or the other domain, in the form of a phase, occurs preferentially within a measuring sub-region (e.g. within a capacitor). In other words, the domain or phase boundaries should rarely occur within a measuring sub-region, (e.g., within a capacitor). Then, average values do not occur frequently.

For example, or ideally, according to the embodiments, the size of the domains may or should correspond to the size of the individual measuring sub-regions, i.e. capacitances in a network of conductive tracks, or be slightly larger. This allows the full dynamics of the value distribution to unfold. If the domains are significantly smaller than the capacitances, mixtures of the components are measured and the two maximums become unclear. If the domains are significantly larger than the capacitances, the maximums are pronounced, but neighboring capacitances have similar values, which reduces the variance of the values available for key generation.

A recommended technical realization (e.g. best practice) according to preferred embodiments is as follows:

According to some embodiments, the thickness of the dielectric layer is exemplarily or even typically selected in the range of 10 μm to 200 μm, preferably 50 μm (e.g. with a tolerance of +/−10%). Depending on a technical possibilities of photolithographic resolution and structuring, the width of the conductive tracks and the spaces between them (line-space, e.g. “line-space geometry”) may be designed in the range of 5 μm and 500 μm, preferably 100 μm (e.g. with a tolerance of +/−10%). This may also be based on the requirements as to security against miniaturized attacks. The number of parallel conductive tracks may depend on the size of the object to be protected and the complexity of the PUF key. It may be designed to range from about 10 to several hundred (e.g. up to 200 or up to 500 or up to 900). The material used to produce the layer is preferably a mix of polymers. For example, they should or may be mixed above a certain temperature or solvent concentration (e.g. to be able to be mixed homogenously) and shows spontaneous demixing below this temperature or concentration. The two phases should or may be as different as possible in terms of physical properties, such as dielectric constant. At the same time, the end product should or may be as stable as possible against environmental influences for a long time to ensure reliable reading of the PUF key over its entire lifetime.

Embodiments include polymer mixtures with a material combination in which a phase separation occurs. One example is a polymer mixture of hPE (hydrogenated polyethylene) and dPP (deuterated polypropene) (see e.g. Wang, H., Composto, R. J. “Wetting and Phase Separation in Polymer Blend Films: Identification of Four Thickness Regimes with Distinct Morphological Pathways.” Interface Science 11, 237-248 (2003), “Wang”) another example is a mixture of the materials dPMMA (deuterated polymethylmethacrylate) and SAN (styrene-acrylonitrile copolymer) (see Wang). A third example is the mixture of the polymers PS (polystyrene) and PVME (polyvinyl methyl ether), whose demixing properties are described in more detail in the following source: Polios, I., Soliman, S, Lee, C., Gido, S., Schmidt-Rohr, K., and Winter, H., “Late Stages of Phase Separation in a Binary Polymer Blend Studied by Rheology, Optical and Electron Microscopy, and Solid State NMR”. Macromolecules 1997, 30, 15, 4470-4480. The publication shows demixing structures that are larger than 100 μm.

This size is especially relevant to conductive tracks widths currently used according to some embodiments, which are used to create the capacitor structures. In addition, the permittivity of the two polymers differs significantly, which can be an advantage when generating a key from the PUF structures later on. The permittivity of PS is approximately 2.5, while the permittivity of PVME is approximately 3.5 (or higher).

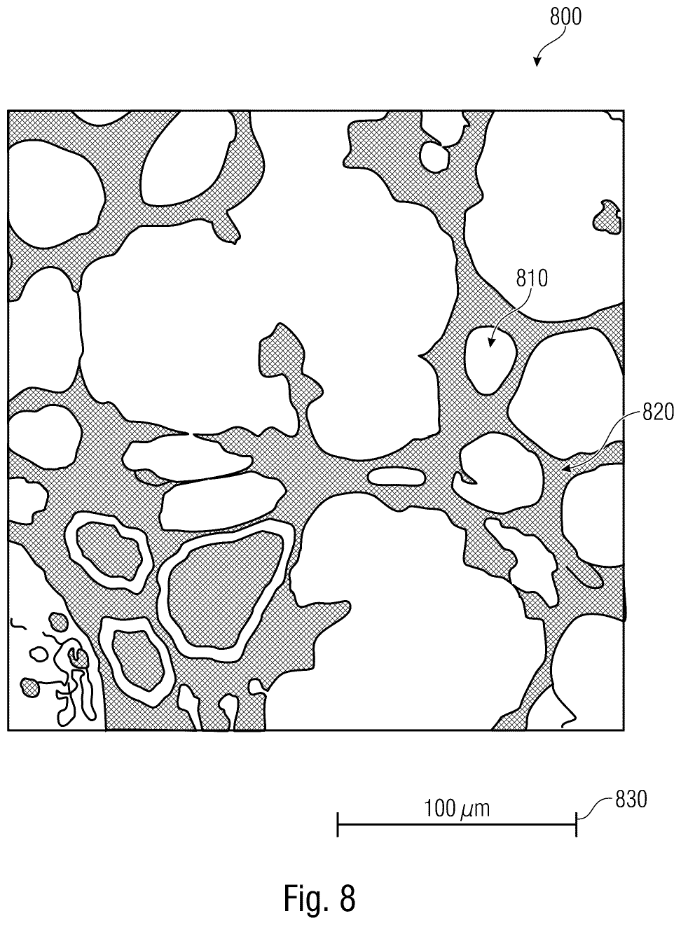

FIG. 8 shows a schematic view of a characteristic structure based on a structure formation by a mixture of PS and PVME. The characteristic structure includes domains 810 and 820 with different properties. The size ratios are shown on a scale of 830.

All the lists of materials, environmental influences, electrical properties, and optical properties given herein are to be considered examples and non-exhaustive.

Even though some aspects have been described within the context of a device, it is understood that said aspects also represent a description of the corresponding method, so that a block or a structural component of a device is also to be understood as a corresponding method step or as a feature of a method step. By analogy therewith, aspects that have been described within the context of or as a method step also represent a description of a corresponding block or detail or feature of a corresponding device. Some or all of the method steps may be performed while using a hardware device, such as a microprocessor, a programmable computer or an electronic circuit. In some embodiments, some or several of the most important method steps may be performed by such a device.

This concerns, e.g., the evaluation of the PUF structures or the detection of an attack on an object to be protected, which is enclosed by an apparatus according to the invention. Embodiments can therefore also have corresponding evaluation units.

Depending on specific implementation requirements, embodiments of the invention may be implemented in hardware or in software. Implementation may be effected while using a digital storage medium, for example a floppy disc, a DVD, a Blu-ray disc, a CD, a ROM, a PROM, an EPROM, an EEPROM or a FLASH memory, a hard disc or any other magnetic or optical memory which has electronically readable control signals stored thereon which may cooperate, or cooperate, with a programmable computer system such that the respective method is performed. This is why the digital storage medium may be computer-readable.

Some embodiments in accordance with the invention thus comprise a data carrier which comprises electronically readable control signals that are capable of cooperating with a programmable computer system such that any of the methods described herein is performed.

Generally, embodiments of the present invention may be implemented as a computer program product having a program code, the program code being effective to perform any of the methods when the computer program product runs on a computer.

The program code may also be stored on a machine-readable carrier, for example.

Other embodiments include the computer program for performing any of the methods described herein, said computer program being stored on a machine-readable carrier.

In other words, an embodiment of the inventive method thus is a computer program which has a program code for performing any of the methods described herein, when the computer program runs on a computer. The data carrier, the digital storage medium, or the recorded medium are typically tangible, or non-volatile.

A further embodiment of the inventive methods thus is a data carrier (or a digital storage medium or a computer-readable medium) on which the computer program for performing any of the methods described herein is recorded.

A further embodiment of the inventive method thus is a data stream or a sequence of signals representing the computer program for performing any of the methods described herein. The data stream or the sequence of signals may be configured, for example, to be transferred via a data communication link, for example via the internet.

A further embodiment includes a processing means, for example a computer or a programmable logic device, configured or adapted to perform any of the methods described herein.

A further embodiment includes a computer on which the computer program for performing any of the methods described herein is installed.

A further embodiment in accordance with the invention includes a device or a system configured to transmit a computer program for performing at least one of the methods described herein to a receiver. The transmission may be electronic or optical, for example. The receiver may be a computer, a mobile device, a memory device or a similar device, for example. The device or the system may include a file server for transmitting the computer program to the receiver, for example.

In some embodiments, a programmable logic device (for example a field-programmable gate array, an FPGA) may be used for performing some or all of the functionalities of the methods described herein. In some embodiments, a field-programmable gate array may cooperate with a microprocessor to perform any of the methods described herein. Generally, the methods are performed, in some embodiments, by any hardware device. Said hardware device may be any universally applicable hardware such as a computer processor (CPU), or may be a hardware specific to the method, such as an ASIC.

The devices described herein may be implemented using, for example, a hardware apparatus, or using a computer, or using a combination of a hardware apparatus and a computer.

The devices described herein, or any components of the devices described herein, may be implemented at least in part in hardware and/or in software (computer program).

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. Method for manufacturing an apparatus for providing a physical unclonable function based on a characteristic structure; the method comprising:
generating the characteristic structure by
locally demixing a precursor to acquire a multitude of domains of a first substance and a multitude of domains of a second substance to acquire a random spatial distribution of the domains over the first and second substances in a measuring region,
wherein domains of the first substance and domains of the second substance differ in a physical property,
so that differences in the physical property at least partially provide the physical unclonable function.

2. Method according to claim 1, comprising:
arranging a measuring structure for a measurement of the physical property at a multitude of sub-regions in the measuring region to evaluate the physical unclonable function.

3. Method according to claim 1,
wherein locally demixing the precursor is carried out by a self-organization and/or a spontaneous structure formation of the first and second substances.

4. Method according to claim 1,
wherein the precursor is provided in a first phase; and
wherein locally demixing the precursor comprises a change of state of the precursor to cause a phase transition to acquire the multitude of domains of the first and second substances.

5. Method according to claim 1,
wherein locally demixing the precursor is caused on the basis of a change of the temperature of the precursor; and/or
wherein locally demixing the precursor is caused on the basis of a change of the ambient pressure of the precursor; and/or
wherein locally demixing the precursor is caused on the basis of an irradiation of the precursor; and/or
wherein locally demixing the precursor is caused by the addition of a catalyst; and/or
wherein the precursor further comprises a solvent and wherein locally demixing the precursor is caused on the basis of an evaporation of the solvent; and/or
wherein locally demixing the precursor is caused on the basis of a polymerization of the precursor.

6. Method according to claim 1,
wherein locally demixing the precursor is caused on the basis of an aggregation of the first substance to first aggregation cores and/or an aggregation of the second substance to second aggregation cores, and the method further comprises:
adding particles to the precursor, wherein the particles are configured to form aggregation cores for the multitude of domains of the first and/or second substance when locally demixing the precursor.

7. Method according to claim 1,
wherein, when locally demixing by means of the change of the ambient conditions, the precursor is decomposed into at least three substances,
wherein the multitude of domains is formed by at least two of the three substances.

8. Method according to claim 1,
wherein the first substance is first polymer and substance is a second polymer;
wherein domains of the first substance and domains of the second substance differ in their dielectric constants so that differences in the physical property at least partially provide the physical unclonable function by means of dielectrics formed by portions of the characteristic layer.

9. Apparatus for providing a physical unclonable function, comprising:
a characteristic structure;
wherein the characteristic structure for the physical unclonable function comprises a measuring region with domains of a first substance and domains of a second substance that differs and is separated from the first substance;
wherein domains of the first substance and domains of the second substance differ in a physical property.

10. Apparatus according to claim 9, further comprising:
a measuring structure configured to measure the physical property at a multitude of sub-regions in the measuring region to evaluate the physical unclonable function.

11. Apparatus for evaluating a physical unclonable function that can be acquired by the manufacturing method according to claim 1.

12. Apparatus according to claim 9,
wherein the apparatus is a flat bendable film or a coating.

13. Apparatus according to claim 12,
wherein a thickness of the characteristic structure of the film or a thickness of the characteristic structure of the coating is essentially constant.

14. Apparatus according to claim 9,
wherein the domain boundaries between the first substance and the second substance extend to a predominant part across an entire thickness of the characteristic structure.

15. Apparatus according to claim 9,
wherein the domains of the first and second substances are configured to not change their relative arrangement with respect to each other and the physical property for at least one year or for at least five years or for at least 10 years, without external influence, or to only change the same to such an extent that the physical unclonable function remains unchanged.

16. Apparatus according to claim 9, with a measuring structure configured to measure the physical property at a multitude of sub-regions in the measuring region to evaluate the physical unclonable function;
wherein the measuring structure comprises conductive tracks in two conductive track planes that cross one another; and
wherein the conductive tracks in the two conductive track planes are configured to form the physical unclonable function by measurement of capacitance values of the characteristic structure at measuring regions at which the conductive paths of the two conductive track planes cross one another.

17. Apparatus according to claim 16,
wherein the characteristic structure is arranged at least partially between the two conductive track planes.

18. Apparatus according to claim 16,
wherein the characteristic structure is arranged at least partially between one of the conductive track planes and at least one shield structure and/or
wherein the characteristic structure is arranged at least partially between a first conductive track plane of the two conductive track planes and a first shield structure and between a second conductive track plane of the two conductive track planes and a second shielding structure.

19. Apparatus according to claim 16,
wherein, in sub-regions at which the conductive tracks of the two conductive track planes cross, a volume of the characteristic structure is formed to at least 75% or at least 80% or at least 90% or at least 95% either by a single domain of the first substance or by a single domain of the second substance.

20. Apparatus according to claim 9,
wherein a ratio of a total volume of domains of the first substance and of domains of the second substance of the characteristic structure is between 30:70 and 70:30.
